(19) United States
(12) Patent Application Publication
(10) Pub. No.: US 2025/0305815 A1
(43) Pub. Date: Oct. 2, 2025

(54) FILM THICKNESS MEASUREMENT DEVICE, FILM THICKNESS MEASUREMENT SYSTEM, AND FILM THICKNESS MEASUREMENT METHOD

(71) Applicant: HONDA MOTOR CO., LTD., Tokyo (JP)

(72) Inventor: Satoshi AOKI, Saitama (JP)

(21) Appl. No.: 19/057,022

(22) Filed: Feb. 19, 2025

(30) Foreign Application Priority Data
Mar. 29, 2024 (JP) 2024-055805

(51) Int. Cl. G01B 11/06; G01B 11/10

(52) U.S. Cl. CPC G01B 11/0691; G01B 11/105

(57) ABSTRACT

A film thickness measurement device according to embodiments includes a measurer. The measurer measures the film thickness of a sheet-shaped member by calculating the difference between a first outer diameter of a roll for transporting the sheet-shaped member with the sheet-shaped member being in contact with the outer peripheral surface of the roll and the total of a second outer diameter of the roll and the film thickness of a portion of the sheet-shaped member that is in contact with the roll.

This application is based on and claims the benefit of priority from Japanese Patent Application No. 2024-055805, filed on 29 Mar. 2024, the content of which is incorporated herein by reference.

### BACKGROUND OF THE INVENTION

### Field of the Invention

The present invention relates to a film thickness measurement device, a film thickness measurement system, and a film thickness measurement method.

### Related Art

In-line measurement devices measure the film thickness of a web by using an optical displacement meter. Such in-line measurement devices include ones that calculate, by using a pair of displacement sensors disposed in such a manner as to have a web interposed therebetween, the thickness of the web on the basis of the distances from the sensors to the web.
Patent Document 1: Japanese Unexamined Patent Application, Publication No. 2010-101656

### SUMMARY OF THE INVENTION

Such in-line measurement devices, which use a pair of displacement sensors, provide a web thickness measurement value directly affected by the influence of the extension/shrinkage of, for example, a frame that occurs in association with a temperature change. Although there are techniques for, for example, providing feedback as to a measurement value from a temperature monitor for frames, the accuracy is low, and temperature shifts of the sensor itself cannot be dealt with.

Embodiments of the present invention are to solve the problem of providing a film thickness measurement device, a film thickness measurement system, and a film thickness measurement method that are more insusceptible to the influence of a temperature change than the prior art.

A film thickness measurement device according to embodiments includes a measurer. The measurer measures the film thickness of a sheet-shaped member by calculating the difference between a first outer diameter of a roll for transporting the sheet-shaped member with the sheet-shaped member being in contact with the outer peripheral surface of the roll and the total of a second outer diameter of the roll and the film thickness of a portion of the sheet-shaped member that is in contact with the roll.

The present invention allows for film thickness measurement that is more insusceptible to the influence of a temperature change than the prior art.

### BRIEF DESCRIPTION OF THE DRAWINGS

FIG. 1 is a block diagram illustrating a measurement system according to embodiments and an example of main configurations of components included in the measurement system;

FIG. 2 is a diagram illustrating a method for measuring the film thickness of a web by using a sensor unit and a guide roll according to embodiments;

FIG. 3 is a flowchart illustrating an example of processing performed by the processor in FIG. 1; and

FIG. 4 is a graph indicating an example of a temporal change in the diameter of the guide roll.

### DETAILED DESCRIPTION OF THE INVENTION

The following describes a measurement system according to embodiments by referring to the drawings. The scale of parts in the drawings used for the description of the embodiments hereinafter may be changed as appropriate. Components in the drawings used for the description of the embodiments hereinafter may be omitted for the purpose of description. Identical reference marks denote similar elements herein and in the drawings.

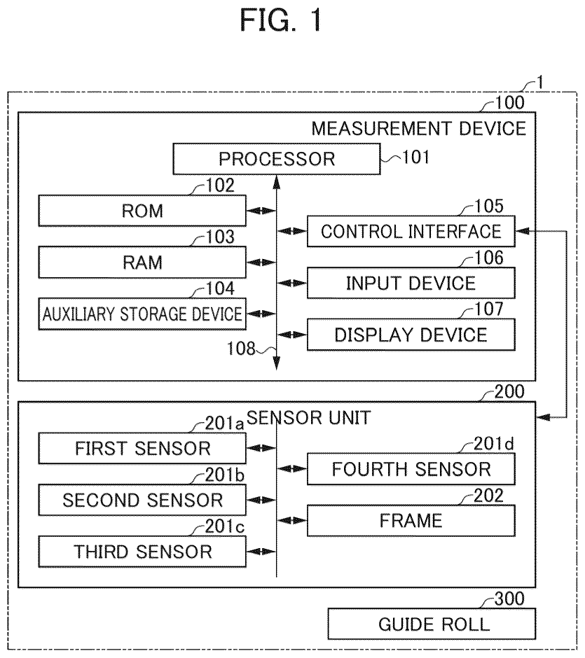

FIG. 1 is a block diagram illustrating a measurement system 1 according to embodiments and an example of main configurations of components included in the measurement system 1. As an example, the measurement system 1 includes a measurement device 100, a sensor unit 200, and a guide roll 300. Note that the measurement system 1 may also include only some of these components. The measurement system 1 measures the film thickness of a web 400. The measurement system 1 is an example of the film thickness measurement system.

The measurement device 100 measures the film thickness of the web 400. For example, the measurement device 100 is a general-purpose device such as a server, a PC, a tablet terminal, or a smartphone. Alternatively, the measurement device 100 may be, for example, a special-purpose device for the measurement system 1. As an example, the measurement device 100 includes a processor 101, a read-only memory (ROM) 102, a random-access memory (RAM) 103, an auxiliary storage device 104, a control interface 105, an input device 106, and a display device 107. These components are connected by, for example, a bus 108. Each component of the measurement device 100 may be internal or external. Note that the measurement device 100 is an example of the film thickness measurement device.

The processor 101, which is a key section of a computer that performs processing such as computation and control required for operations of the measurement device 100, performs, for example, various types of computation and processing. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of a plurality of ones of these elements. The processor 101 may also be these elements with, for example, a hardware accelerator combined therewith. In order to implement various types of functions of the measurement device 100, the processor 101 controls each component on the basis of programs such as firmware, system software, and application software stored in, for example, the ROM 102 or the auxiliary storage device 104. The processor 101 also performs the processing described hereinafter on the basis of the programs. Some of or all of the programs may be incorporated into a circuit of the processor 101.

The ROM 102 and the RAM 103 are main storage devices for the computer that has the processor 101 as a key component. The ROM 102 is a nonvolatile memory used exclusively for data reading. The ROM 102 stores, for example, the firmware from among the abovementioned programs. The ROM 102 also stores, for example, data used by the processor 101 when performing various types of processing.

The RAM 103 is used for data reading or writing. The RAM 103 is used as, for example, a work area in which is stored data that is temporarily used by the processor 101 when performing various types of processing. The RAM 103 is typically a volatile memory.

The auxiliary storage device 104 is one for the computer that has the processor 101 as a key component. The auxiliary storage device 104 is, for example, an electric erasable programmable read-only memory (EEPROM), a hard disk drive (HDD), or a flash memory. The auxiliary storage device 104 stores, for example, the system software and the application software from among the abovementioned programs. The auxiliary storage device 104 also stores, for example, data used by the processor 101 when performing various types of processing, data generated through the processing performed by the processor 101, and various types of setting values.

The control interface 105 allows the measurement device 100 to communicate with the sensor unit 200. The measurement device 100 controls the sensor unit 200 via the control interface 105.

The input device 106 accepts an operation performed by the operator of the measurement device 100. The input device 106 is, for example, a keyboard, a keypad, a touch pad, a mouse, or a controller. The input device 106 may also be a device for speech input.

The display device 107 displays a screen for informing various types of information to, for example, the operator of the measurement device 100. The display device 107 is, for example, a liquid-crystal display or an organic electro-luminescence (EL) display. A touch panel may be used as the input device 106 and the display device 107. In particular, the display panel of the touch panel may be used as the display device 107, and the touch-input pointing device of the touch panel may be used as the input device 106.

The bus 108 includes, for example, a control bus, an address bus, and a data bus and carries signals to be communicated between the components of the measurement device 100.

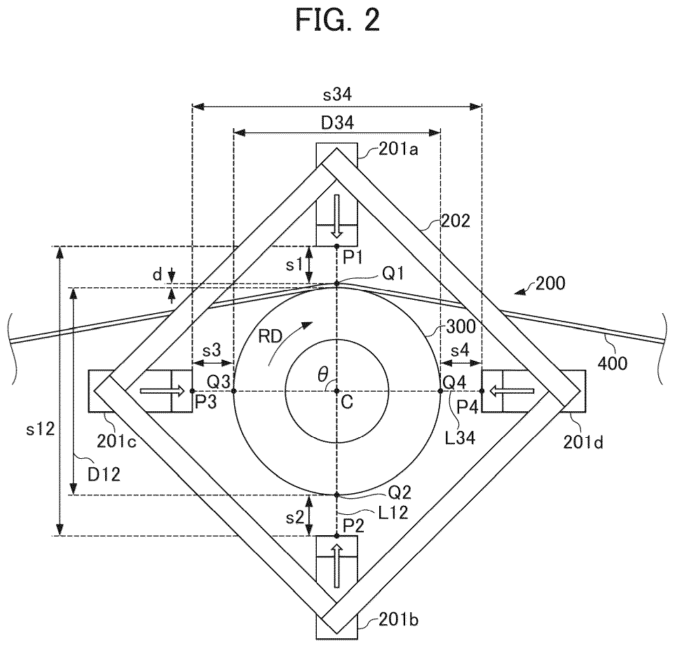

Descriptions are given of the sensor unit 200, the guide roll 300, and the web 400 by referring to FIG. 2. FIG. 2 illustrates a method for measuring the film thickness d of the web 400 by using the sensor unit 200 and the guide roll 300 according to embodiments.

The sensor unit 200 is a device that uses a plurality of sensors 201 so as to measure the distance from each of the sensors 201 to an object. As an example, the sensor unit 200 includes sensors 201 and a frame 202. The sensor unit 200 includes four sensors 201, namely, a first sensor 201a, a second sensor 201b, a third sensor 201c, and a fourth sensor 201d. For example, the communication between the sensor unit 200 and the measurement device 100 is performed by each of the sensors 201 individually communicating with the measurement device 100. Alternatively, the sensor unit 200 may be provided with a communication device. The sensor unit 200 communicates with the measurement device 100 by using the communication device.

The sensor 201 can measure a distance. For example, the sensor 201 is a displacement sensor that measures the distance from the sensor 201 to an object. The sensor 201 is typically an optical displacement sensor. However, the sensor 201 may also be a displacement sensor that uses another scheme, such as an ultrasonic, capacitive, tactile, or eddy current sensor.

The first sensor 201a and the second sensor 201b are opposed to each other with the guide roll 300 and the web 400 therebetween. The first sensor 201a is positioned on the side close to the web 400. The second sensor 201b is positioned on the side close to the guide roll 300. The web 400 is an object to be subjected to measurement performed by the first sensor 201a. The first sensor 201a measures a distance s1 from a point P1 to a point Q1. The point P1 indicates the position of the first sensor 201a. The point Q1 is located on a surface of the web 400 on the opposite side of the portion of the web 400 that is in contact with the guide roll 300.

The guide roll 300 is an object to be subjected to measurement performed by the second sensor 201b, the third sensor 201c, and the fourth sensor 201d. The second sensor 201b measures a distance s2 from a point P2 to a point Q2. The point P2 indicates the position of the second sensor 201b. The point Q2 is located on the surface of the guide roll 300. More specifically, the point Q2 is the point that is closer to the second sensor 201b, from among the points of intersection of the surface of the guide roll 300 and a straight line L12 linking the points P1 and P2. The straight line L12 preferably passes a rotation axis C of the guide roll 300. Thus, the first sensor 201a and the second sensor 201b are both preferably oriented toward the rotation axis C. Note that the distance between the first sensor 201a and the second sensor 201b, i.e., the distance between the points P1 and P2, is hereinafter referred to as the “distance s12.”

The third sensor 201c and the fourth sensor 201d are opposed to each other with the guide roll 300 therebetween. The web 400 is not present between the third sensor 201c and the fourth sensor 201d. The third sensor 201c measures a distance s3 from a point P3 to a point Q3. The point P3 indicates the position of the third sensor 201c. The point Q3 is located on the surface of the guide roll 300. More specifically, the point Q3 is the point that is closer to the third sensor 201c, from among the points of intersection of the surface of the guide roll 300 and a straight line L34 linking the points P3 and P4. The point P4 indicates the position of the fourth sensor 201d.

The fourth sensor 201d measures a distance s4 from a point P4 to a point Q4. The point Q4 is located on the surface of the guide roll 300. More specifically, the point Q4 is the point that is closer to the fourth sensor 201d, from among the points of intersection of the straight line L34 and the surface of the guide roll 300. The straight line L34 preferably passes the rotation axis C of the guide roll 300. Thus, the third sensor 201c and the fourth sensor 201d are both preferably oriented toward the rotation axis C. Note that the distance between the third sensor 201c and the fourth sensor 201d, i.e., the distance between the points P3 and P4, is hereinafter referred to as the “distance s34.” Although the distances s12 and s34 may be different, the two are preferably the same.

The straight lines L12 and L34 are both preferably perpendicular to the rotation axis C. An angle θ formed by the straight lines L12 and L34 is preferably perpendicular. However, the angle θ does not necessarily need to be perpendicular. The straight lines L12 and L34 preferably intersect each other.

The frame 202 is a member for fixing the four sensors 201 such that the four sensors 201 have positional relationships such as those noted above. A material for the frame 202 is not limited, but may be, for example, a metal or a resin. A material for the frame 202 preferably undergoes little deformation when a temperature change occurs.

The third sensor 201c and the fourth sensor 201d are a pair of sensors opposed to each other with a roll therebetween. Thus, the third sensor 201c and the fourth sensor 201d are an example of the first distance measurer. The first sensor 201a and the second sensor 201b are a pair of sensors opposed to each other with a roll and a sheet-shaped member therebetween in such a manner as to be orthogonal to the first distance measurer. Thus, the first sensor 201a and the second sensor 201b are an example of the second distance measurer.

The guide roll 300 is used to transport the web 400. The guide roll 300 can rotate about the rotation axis C. For example, the guide roll 300 is a free roll that rotates in accordance with the transport of the web 400. Alternatively, the guide roll 300 may transport the web 400 by rotating with a moving force from, for example, a motor. For example, the guide roll 300 is column-shaped. Thus, the outer circumference of a cross section of the guide roll 300 is, for example, circular. However, the outer circumference of the cross section of the guide roll 300 may not constitute a perfect circle due to an error associated with, for example, tolerances. The shape of the outer circumference of the cross section of the guide roll 300 is not limited to a circle but may be an ellipse. Furthermore, the shape of the outer circumference of the cross section of the guide roll 300 may be another simple closed curve. However, the larger difference from a circle the shape of the outer circumference of the cross section of the guide roll 300 has, the less smoothly the web 400 is transported, so it is more preferable that the shape of the outer circumference is closer to a circle. In FIG. 2, a rotation direction RD of the guide roll 300 is the direction from the point Q3 toward the point Q1. Note that the guide roll 300 is an example of the roll for transporting the sheet-shaped member with the sheet-shaped member being in contact with the outer peripheral surface of the roll.

The web 400 is a sheet-shaped object to be transported. Various sheet-shaped webs of, for example, metal foil, resin sheets, or others may be the web 400. As an example, the web 400 is a sheet-shaped positive electrode for an all-solid-state battery. Note that the web 400 is an example of the sheet-shaped member.

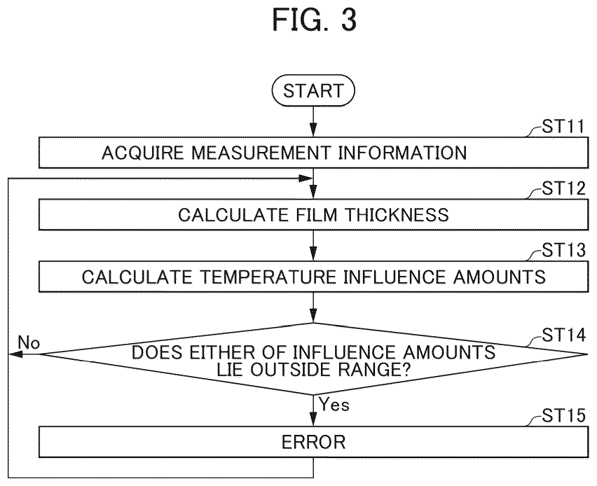

The following describes operations of the measurement system 1 according to embodiments on the basis of, for example, FIG. 3. Details of the processing in the following descriptions of operations are exemplary, and various types of processing with which similar results can be obtained may be used, as appropriate. FIG. 3 is a flowchart illustrating an example of the processing performed by the processor 101 of the measurement device 100. The processor 101 performs the processing in FIG. 3 on the basis of a program stored in, for example, the ROM 102 or the auxiliary storage device 104.

The processor 110 of the measurement device 100 performs the processing indicated in FIG. 3 when measuring the film thickness of the web 400.

In step ST11 in FIG. 3, the processor 101 of the measurement device 100 starts to acquire measurement information. The measurement information indicates a measurement result from each of the sensors 201. The measurement information includes the distances s1 to s4. The processor 101 acquires the measurement information from the sensor unit 200 via the control interface 105.

In step ST12, the processor 101 measures the film thickness d of the web 400. The processor 101 measures the film thickness d by calculating the film thickness d by using the measurement information acquired in step ST11.

For example, the processor 101 can calculate the film thickness d by using the following equation.

$$d = ( D 12 + d ) - D 34 \qquad ( 1 )$$

In this equation, the diameter D12 is the diameter of the guide roll 300 in the direction of the straight line L12. The diameter D34 is the diameter of the guide roll 300 in the direction of the straight line L34. Thus, the following equations can be represented.

$$( D 12 + d ) = ( s 12 - s 1 - s 2 ) \qquad ( 2 )$$

$$D 34 = ( s 34 - s 3 - s 4 ) \qquad ( 3 )$$

The diameter D34 is an example of the first diameter. The diameter D12 is an example of the second diameter.

Accordingly, equation (1) can be represented as the following equation.

$$d = ( s 12 - s 1 - s 2 ) - ( s 34 - s 3 - s 4 ) \qquad ( 4 )$$

When s12 and s34 are equal, the processor 101 can calculate the film thickness d in accordance with the following equation.

$$d = ( s 3 + s 4 ) - ( s 1 + s 2 ) \qquad ( 5 )$$

The straight lines L12 and L34 are different in position by the angle θ. Thus, for the distances s1 to s4 in equation (4) or (5), the processor 101 uses the values of the averages of measurement values obtained within a prescribed period. For example, the prescribed period is a preset length of time, or a period that is taken for the guide roll 300 to rotate by a preset angle. The time is preferably one that is taken for the guide roll 300 to rotate by a multiplex of 360°. The angle is preferably a multiplex of 360°. The influence of the difference in position of angle θ can be reduced by using the values of the averages.

D34 and (s3+s4) are each an example of the amount indicating the first outer diameter.

(D12+d) and (s1+s2) are each an example of the amount indicating the total of the second outer diameter and the film thickness.

Alternatively, the processor 101 may use, in equation (4) or (5), a distance s3 and a distance s4 measured at a first measurement timing and a distance s1 and a distance s2 measured at a second measurement timing. The second measurement timing comes when the guide roll 300 has rotated by the angle θ after the first measurement timing.

The diameter D34 is an example of the first outer diameter. The diameter D12 is an example of the second outer diameter. Thus, equations (1), (4), and (5) are each an example of the numerical equation for calculating the difference between the first outer diameter and the total of the second outer diameter and the film thickness. Accordingly, by performing the process of step ST12, the processor 101 functions as an example of the measurer that measures the film thickness of a sheet-shaped member by calculating the difference between a first outer diameter of a roll for transporting the sheet-shaped member with the sheet-shaped member being in contact with the outer peripheral surface of the roll and the total of a second outer diameter of the roll and the film thickness of a portion of the sheet-shaped member that is in contact with the roll.

In step ST13, the processor 101 calculates a temperature influence amount n and a temperature influence amount m. The temperature influence amount n indicates the degree of influence exerted on a measurement value by a temperature change of the guide roll 300 and the frame 202. The temperature influence amount m indicates the degree of influence exerted on a measurement value by a temperature change of the sensor 201.

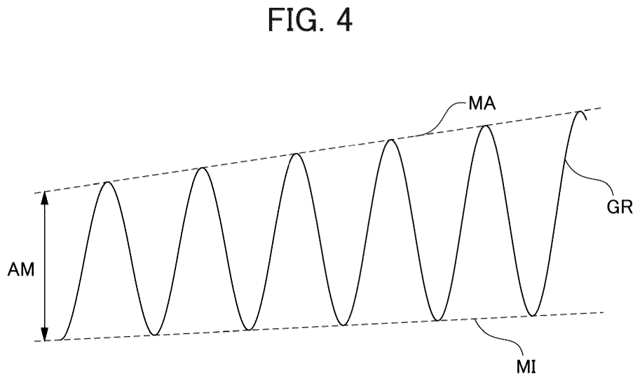

For example, the diameter D34 exhibits a change such as that indicated by a graph GR depicted in FIG. 4. FIG. 4 is a graph indicating an example of a temporal change in the diameter D34 of the guide roll 300. This graph is provided when the temperature of the guide roll 300 and the temperature of the frame 202 and the sensor 201 increases. The vertical axis of the graph indicated in FIG. 4 indicates the length of the diameter, and the horizontal axis thereof indicates time. In the example indicated in FIG. 4, the outer circumference of the cross section of the guide roll 300 has the shape of an ellipse. Thus, the diameter D34 exhibits a periodic waveform in accordance with the rotation of the guide roll 300. The cycle is a time taken for the guide roll to make one full rotation. A more complicated waveform will be exhibited if the outer circumference of the cross section of the guide roll 300 has an uneven shape due to an error. In FIG. 4, the amplitude AM of the graph GR increases with time. This is considered to indicate that the guide roll 300 and the frame 202 are deformed due to a temperature change. As the temperature of the guide roll 300 and the frame 202 rises, the amplitude AM becomes larger. The processor 110 calculates the amplitude AM and uses this value as a temperature influence amount n1. Alternatively, the processor 110 may use, as a temperature influence amount n2, a value indicating a multiple of a reference amplitude. That is,

$$n 2 = ( amplitude AM ) / ( reference amplitude ) \qquad ( 6 )$$

The temperature influence amount n2 indicates that the guide roll 300 and the frame 202 have expanded n2 times in size. Note that the temperature influence amount n1 and the temperature influence amount n2 are both an example of the temperature influence amount n.

In FIG. 4, the minimum value MI and the maximum value MA of the graph GR also increase with time. The amounts of increase are based on the combination of the influence of the temperature change of the sensor 201 and the influence of the temperature change of the guide roll 300 and the frame 202. In particular, the minimum value MI becomes higher as the temperature of the sensor 201 rises.

For example, assuming that the minimum value has been changed from MI1 to MI2 and that the maximum value has been changed from MA1 to MA2, the following equations can be represented.

$$n 2 ( MA 1 ) + m 1 = MA 2 \qquad ( 7 )$$

$$n 2 ( MI 1 ) + m 1 = MI 2 \qquad ( 8 )$$

In these equations, m1 indicates that, due to the temperature change of the sensor, the diameter of the guide roll 300 plus m1 is measured. Solving these simultaneous equations provides the following equations.

$$m 1 = ( MA 1 \cdot MI 2 - MA 2 \cdot MI 1 ) / ( MA 1 - MI 1 ) \qquad ( 9 )$$

$$n 2 = ( MA 2 - MI 2 ) / ( MA 1 - MI 1 ) \qquad ( 10 )$$

The processor 110 uses the solution m1 of these simultaneous equations as the temperature influence amount m1. The processor 110 may also use preset reference values as MI1 and MA1. In this case, (MA1−MI1) is a reference amplitude. In the meantime, the processor 110 may use MI2 or (MI2/MI1) as a temperature influence amount m2 without taking the influence of the temperature change of the guide roll 300 and the frame 202 into consideration. Note that the temperature influence amount m1 and the temperature influence amount m2 are both an example of the temperature influence amount m.

The graph GR indicates an example of a cyclic variation in the outer diameter of the roll. The amplitude AM indicates an example of the amplitude of the cyclic variation in the outer diameter of the roll. The temperature influence amount n is an example of the first amount that indicates the degree of influence exerted on the measurement of the film thickness by the temperature change of the roll, the first amount being calculated using the amplitude of the cyclic variation in the outer diameter of the roll. The temperature influence amount m is an example of the second amount that indicates the degree of influence exerted on the measurement of the film thickness by the temperature change of the distance measurer for measuring the first outer diameter and the total from the minimum value of the cyclic variation. Thus, by performing the process of step ST13, the processor 101 functions as an example of the calculator that calculates the first amount and the second amount.

In step ST14, the processor 101 determines whether at least either the temperature influence amount n or the temperature influence amount m lies outside a prescribed range. For example, the processor 110 determines that the temperature influence amount n lies outside the prescribed range when the temperature influence amount n is no greater than a threshold TH1 or no less than a threshold TH2. The threshold TH2 is higher than the threshold TH1. The threshold TH1 indicates that the amount of deformation of the guide roll 300 and the frame 202 is larger than a prescribed amount due to the temperature of the guide roll 300 and the frame 202 being excessively low. The threshold TH2 indicates that the amount of deformation of the guide roll 300 and the frame 202 is larger than the prescribed amount due to the temperature of the guide roll 300 and the frame 202 being excessively high. For example, the processor 110 determines that the temperature influence amount m lies outside the prescribed range when the temperature influence amount m is no greater than a threshold TH3 or no less than a threshold TH4. The threshold TH4 is higher than the threshold TH3. The threshold TH3 indicates that the influence on the measurement value is higher than a prescribed value due to the temperature of the sensor 201 being excessively low. The threshold TH4 indicates that the influence on the measurement value is higher than the prescribed value due to the temperature of the sensor 201 being excessively high. If the temperature influence amounts n and m both lie within the prescribed range, the processor 101 gives a determination of No in step ST14 and returns to step ST12. Meanwhile, if at least either of the temperature influence amounts n and m lies outside the prescribed range, the processor 101 gives a determination of Yes in step ST14 and shifts to step ST15.

In step ST15, on the basis of the result of determination in step ST14, the processor 101 gives a notification that at least either an error indicating that the temperature of the guide roll 300 and the frame 202 lies outside the prescribed range or an error indicating that the temperature of the sensor 201 lies outside the prescribed range has occurred. Thus, for example, the processor 101 generates an image corresponding to an error screen. Then, the processor 101 instructs the display device 107 to display the generated image. Upon receipt of the instruction to display, the display device 107 displays the error screen. The error screen indicates that the error has occurred. After the process of step ST15, the processor 101 returns to step ST12.

The measurement system 1 according to embodiments measures the film thickness d by calculating the difference between the diameter D34 and the total of the diameter D12 and the film thickness d. When the temperature of the guide roll 300 has changed, the diameters D34 and D12 change similarly to each other. Thus, the measurement system 1 according to embodiments undergoes a smaller amount of influence exerted on the measurement of the film thickness d by a temperature change than the prior art. Although the diameters D34 and D12 are different in position by the angle θ, the two indicate diameters of the same guide roll 300 and thus similarly cyclically vary in the presence of a mere phase difference. Accordingly, in comparison with the prior art, the measurement system 1 according to embodiments is insusceptible to an influence that is exerted on the measurement of the film thickness d due to the guide roll 300 not constituting a perfect circle.

As an example, the measurement system 1 according to embodiments uses a positive electrode sheet for a battery as the web 400. A positive electrode sheet for a battery has a thickness of only several tens of micrometers and is largely affected, in terms of film thickness measurement, by a temperature shift of the sensor 201 and thermal expansion/contraction of the frame 202. The measurement system 1 according to embodiments is suitable for measuring a film thickness on the order of micrometers, such as the film thickness of a positive electrode sheet for a battery. The measurement system 1 according to embodiments can perform accurate in-line measurement of the thickness of the web 400 during fast transport. The measurement system 1 according to embodiments can also be used for film thickness measurement that involves performing in-line measurement of a positive electrode material provided by applying positive electrode slurry to a base material and forming the resultant structure into the shape of a sheet through a drying process, or for film thickness measurement that is performed after pressing in a later roll press process.

The measurement system 1 according to embodiments calculates the temperature influence amount n and the temperature influence amount m. The temperature influence amount n indicates an influence exerted on the measurement of the film thickness d by a temperature change of the guide roll 300. The temperature influence amount m indicates an influence exerted on the measurement of the film thickness d by a temperature change of the sensor 201. Hence, the measurement system 1 according to embodiments can evaluate the influence on the measurement of the film thickness d, with the temperature change of the guide roll 300 and the temperature change of the sensor 201 being distinguished from each other. Meanwhile, by using the temperature influence amount n and the temperature influence amount m, the measurement system 1 according to embodiments can give a notification if an influence exerted on the measurement of the film thickness d by a temperature is higher than a prescribed level.

The measurement system 1 according to embodiments includes the third sensor 201c and the fourth sensor 201d, which measure the diameter D34 or (distance s3+distance s4). The measurement system 1 according to embodiments also includes the first sensor 201a and the second sensor 201b, which measure (diameter D12+film thickness d) or (distance s1+distance s2). Thus, the measurement system 1 according to embodiments can concurrently measure the diameter D34 or (distance s3+distance s4) and (diameter D12+film thickness d) or (distance s1+distance s2).

The angle θ is preferably perpendicular in the measurement system 1 according to embodiments. When the angle θ is perpendicular, the measurement system 1 according to embodiments can suppress an influence exerted on the measurement of the film thickness d by a temperature change of the frame 202.

The following variations of the embodiments described above are also possible.

The measurement system 1 may include a device in which the measurement device 100 and the sensor unit 200 are integrated.

Each device in embodiments may be formed from a plurality of devices. Each device in embodiments may be implemented using cloud computing.

By using the hardware configuration of a circuit, the processor 101 may implement a portion of or the entirety of the processing implemented by the program in the embodiments described above.

The program for implementing the processing in embodiments is handed over in, for example, a state of being stored in a non-transitory computer-readable storage medium in a device. However, this device may be handed over without the program being stored therein. The program may be handed over separately and written to the device. For example, the handover of the program in this situation can be achieved by recording the same in a non-transitory removable computer-readable storage medium or by downloading the same via a network such as the Internet or a local area network (LAN).

Although embodiments of the present invention have been described, such embodiments are indicated as examples and do not limit the scope of the present invention. Embodiments of the present invention can be implemented in various aspects without departing from the gist of the present invention.

### EXPLANATION OF REFERENCE NUMERALS

1: Measurement system
100: Measurement device
101: Processor
102: ROM
103: RAM
104: Auxiliary storage device
105: Control interface
106: Input device
107: Display device
108: Bus
200: Sensor unit
201a: First sensor
201b: Second sensor
201c: Third sensor
201d: Fourth sensor
202: Frame
300: Guide roll
400: Web

What is claimed is:

1. A film thickness measurement device comprising:
a measurer that measures a film thickness of a sheet-shaped member by calculating a difference between a first outer diameter of a roll for transporting the sheet-shaped member with the sheet-shaped member being in contact with an outer peripheral surface of the roll and a total of a second outer diameter of the roll and a film thickness of a portion of the sheet-shaped member that is in contact with the roll.

2. The film thickness measurement device according to claim 1, the film thickness measurement device further comprising:
a calculator that calculates, by using an amplitude of a cyclic variation in an outer diameter of the roll, a first amount indicating a degree of influence exerted on the measurement of the film thickness by a temperature change of the roll, and also calculates a second amount indicating a degree of influence exerted on the measurement of the film thickness by a temperature change of a distance measurer for measuring the first outer diameter and the total by using a minimum value of the cyclic variation.

3. A film thickness measurement system comprising
distance measurers; and
a film thickness measurement device, wherein
the distance measurers measure a first outer diameter of a roll for transporting a sheet-shaped member with the sheet-shaped member being in contact with an outer peripheral surface of the roll and a total of a second outer diameter of the roll and a film thickness of a portion of the sheet-shaped member that is in contact with the roll, and
the film thickness measurement device is provided with a measurer for measuring the film thickness by calculating a difference between the first outer diameter and the total.

4. The film thickness measurement system according to claim 3, wherein
the film thickness measurement system includes a first one of the distance measurers and a second one of the distance measurers that differs from the first distance measurer,
the first distance measurer measures an amount indicating the first outer diameter, and
the second distance measurer measures an amount indicating the total.

5. The film thickness measurement system according to claim 4, wherein
the first distance measurer is a pair of sensors opposed to each other with the roll therebetween, and
the second distance measurer is a pair of sensors opposed to each other with the roll and the sheet-shaped member therebetween in such a manner as to be orthogonal to the first distance measurer.

6. A film thickness measurement method comprising:
measuring a film thickness of a sheet-shaped member by calculating a difference between a first outer diameter of a roll for transporting the sheet-shaped member with the sheet-shaped member being in contact with an outer peripheral surface of the roll and a total of a second outer diameter of the roll and a film thickness of a portion of the sheet-shaped member that is in contact with the roll.
